(19) United States
(12) Patent Application Publication
(10) Pub. No.: US 2008/0206513 A1
(43) Pub. Date: Aug. 28, 2008

(54) Composite Elements, Comprising Nonwoven Thermoplastic Polyurethane Fabric

(75) Inventors: Hauke Malz, Diepholz (DE); Toprak Serhatkulu, Grosse Ile, MI (US); Marita Schuster, Stemwede-Haldem (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESSELLSCHAFT, LUDWIGSHAFEN (DE)

(21) Appl. No.: 11/916,037

(22) PCT Filed: May 30, 2006
(86) PCT No.: PCT/EP2006/062731

§ 371 Date: Nov. 30, 2007

(30) Foreign Application Priority Data
Jun. 3, 2005 (DE) 102005025980.4

(51) Int. Cl. B32B 3/26; B32B 33/00; B32B 27/40

(52) U.S. Cl. 428/95; 428/319.3; 264/257

(57) ABSTRACT

This invention relates to composite elements comprising a polyurethane foam (i), a nonwoven of thermoplastic polyurethane (ii) and if appropriate a covering layer (iii), and also to a process for their production and to the use of this invention's composite elements as seats or carpets.

This invention relates to composite elements comprising a polyurethane foam (i), a nonwoven of thermoplastic polyurethane (ii) and if appropriate a covering layer (iii), and also to a process for their production and to the use of this invention's composite elements as seats or carpets.

Polyurethane is a versatile and widely used material of construction. It can be made from an immense range of raw materials, to have the most diverse properties, examples of polyurethane products being rigid foams for insulation, flexible foam blocks for mattresses, molded flexible foams for auto seats and seat padding, acoustical foams for noise abatement, thermoplastic foams, shoe foams or microcellular foams, but also compact casting systems and thermoplastic polyurethanes.

A technically advantageous way to produce molded foams for auto seats is for the textile cover for the auto seat to be placed in the mold and to be directly backfoamed by generating the foam in situ on the back of the textile cover. But there is a disadvantage with this in that the viscosity of the foam system is low at the start of the foaming operation. In addition, the pressure which develops in the mold during the foaming causes the foam to be forced through the pores in the textile cover. A foil has to be placed between the foam and the textile cover in order that strikethrough of the foam through the textile may be prevented. But this foil reduces the water vapor transmission rate of the textile and also the sound-absorbing ability of the foam. This leads to a substantial reduction in the comfort afforded by auto seats for example.

Alternatively, DE 19811472 describes a thixotropic PU system which is said to reduce the degree of penetration into a textile covering layer. However, the viscosity of this system is too high in that the resulting poor flowability does not permit backfoaming of complex geometries.

It has accordingly been found that it is advantageous to substitute a nonwoven for the foil in such molded foams.

Composite elements consisting of polyurethane and nonwovens are described in GB 2 235 651. However, the composite elements described therein, which comprise nonwovens of polyethylene terephthalate or polyamide, do not have satisfactory properties, in particular with regard to elasticity, haptics, bonding between the polyurethane matrix and the nonwoven, and water vapor transmission rate. In addition, the composite elements described are a combination of two materials of construction.

This does not exactly make for convenient recycling, which benefits from a stream of a single material.

The present invention has for its object to develop a combination of a covering layer and a foam for a composite element (for example for a composite element in the form of an auto seat) where there is no need for a protective foil. The present invention further has for its object to replace the protective foil such that the covering layer can be omitted if appropriate.

The present invention has for its object in particular to provide a composite element comprising an optional covering layer and a polyurethane foam and having advantageous properties with regard to the intended use of the composite element. It is accordingly an object to provide a composite element having a high water vapor transmission rate, good elasticity, good bonding between the covering layer and the foam, good haptics, good visuals and convenient (single material) recyclability.

It is likewise an object of the present invention to provide a process for producing a composite element having the aforementioned advantageous properties, which process shall preferably be particularly economical to operate. It is consequently an object of the present invention to provide a process having short cycling times and a low reject rate. It is in particular an object of the present invention to provide a process for producing the abovementioned composite element that has the aforementioned advantages wherein the liquid components of the polyurethane system are very easy to apply to the covering layer without the foam penetrating the covering layer and so impairing the visuals of the covering layer.

We have found that these objects are achieved by a composite element comprising a polyurethane foam and also a nonwoven of thermoplastic polyurethane (herein also referred to as TPU) and an optional covering layer and also a process for producing the composite element.

The present invention accordingly provides a composite element comprising
i) a polyurethane foam,
ii) a nonwoven of thermoplastic polyurethane, and
iii) if appropriate a covering layer.

The optional covering layer (iii) is typically a material which endows the composite element with a decorative appearance. The material may be natural or synthetic. Suitable covering layers are metal foils, polymeric foils, polymeric skins, textiles, webs and/or leather.

Examples of suitable textiles are wovens and knits. In particular those comprising manufactured fibers such as polyamide, polyesters such as polyethylene terephthalate and polybutylene terephthalate, polyacrylonitrile, polyolefins, polypropylene, viscose. Also wovens or knits comprising natural fibers such as wool, cotton, silk, linen, etc. Suitable textiles further include nonwovens comprising manufactured fibers such as polypropylene, polyolefin copolymers, styrene copolymers, polyamides, polyesters such as polyethylene terephthalate and polybutylene terephthalate, polyacrylonitrile, TPU, polyetheresters, polyetherethers, polyesterethers and also nonwovens comprising natural fibers such as silk, cotton, wool, linen, etc.

Examples of suitable plastics are foils of PVC, polyolefins, thermoplastic polyurethanes or mixtures or composites thereof.

Preference is given to using textiles comprising manufactured fibers and/or natural fibers.

The thickness of the covering layer is generally in the range from 0.05 to 5 millimeters (mm), preferably in the range from 0.1 to 2 mm and more preferably in the range from 0.2 to 1.2 mm. The covering layer may be in a single color or different colors. Having different colors includes having colored patterns.

Constituent (ii) of the composite element according to the present invention comprises one or more nonwovens. A nonwoven is a layer, web and/or lap of directionally aligned or randomly disposed fibers, consolidated by friction and/or cohesion and/or adhesion.

Paper or articles of manufacture which have been woven, knitted, tufted, stitch bonded through incorporation of binding yarns or filaments, or felted by a wet-fulling operation are preferably not treated as nonwovens for the purposes of this invention.

In a preferred embodiment, a material is to be deemed a nonwoven (ii) for the purposes of this invention when more than 50% and in particular from 60% to 90% of the mass of its fibrous constituent consists of fibers having a length to diameter ratio of more than 300 and in particular of more than 500.

In a preferred embodiment, the diameters of the individual fibers of the nonwoven are in the range from 50 μm to 0.1 μm, preferably in the range from 10 μm to 0.5 μm and in particular in the range from 7 μm to 0.5 μm.

In a preferred embodiment, the thickness of the nonwoven (ii) is in the range from 0.01 to 5 millimeters (mm), more preferably in the range from 0.1 to 2 mm, even more preferably in the range from 0.2 to 1.5 mm and especially in the range from 0.3 to 1 mm, measured to ISO 9073-2.

In a preferred embodiment, the basis weight of the nonwovens (ii) is in the range from 20 to 500 g/m², more preferably in the range from 50 to 250 g/m² and even more preferably in the range 90-160 g/m², measured to ISO 9073-1.

The nonwoven may additionally be mechanically consolidated. Mechanical consolidation may take the form of singlesided or bothsided mechanical consolidation; bothsided mechanical consolidation is preferred.

In addition to the afore-described mechanical consolidation, the nonwoven may further be thermally consolidated. Thermal consolidation may be effected for example by subjecting the nonwoven to a treatment with hot air.

The nonwoven (ii) may have the following four parameters (P1 to P4) in preferred embodiments:
P1) An embodiment utilizes a nonwoven (ii) which has a machine direction tensile strength in the range from 10 newtons (N) per 5 cm to 1000 N per 5 cm, preferably in the range from 40 N per 5 cm to 1000 N per 5 cm, and in particular of 200-1000 N per 5 cm (measured to DIN EN 12127).
P2) An embodiment utilizes a nonwoven (ii) which has a cross direction tensile strength in the range from 10 newtons (N) per 5 cm to 1000 N per 5 cm, preferably in the range from 40 N per 5 cm to 1000 N per 5 cm, and in particular of 200-1000 N per 5 cm (measured to DIN EN 12127).
P3) An embodiment utilizes a nonwoven (ii) which has a machine direction extension in the range from 10% to 800%, preferably in the range from 50% to 800% and especially in the range from 250% to 800%, measured to DIN EN 29073 Part 3.
P4) An embodiment utilizes a nonwoven (ii) which has a cross direction extension in the range from 10% to 800%, preferably in the range from 50% to 800% and especially in the range from 250% to 800%, measured to DIN EN 29073 Part 3.

In a preferred embodiment, the nonwoven (ii) comprises at least two, more preferably at least 3 and especially all the P1 to P4 features.

A further preferred embodiment utilizes a nonwoven (ii) which is single layered, i.e., only one fiber mixture is utilized throughout the thickness of the nonwoven.

The utilized nonwoven (ii) is of thermoplastic polyurethane. This is to be understood as meaning that the utilized nonwoven (ii) comprises a thermoplastic polyurethane, preferably as an essential constituent. A preferred embodiment utilizes a nonwoven (ii) comprising thermoplastic polyurethane in an amount of 60% by weight to 100% by weight, more preferably of more than 80% by weight and especially more than 97% by weight, based on the total weight of the nonwoven.

As well as thermoplastic polyurethane, the utilized nonwoven (ii) may further comprise other polymers or auxiliaries, examples being polypropylene, polyethylene and/or polystyrene and/or copolymers of polystyrene such as styrene-acrylonitrile copolymers.

Thermoplastic polyurethanes are polyurethanes which, when repeatedly heated and cooled in the temperature range typical for processing and using the material of construction, remain thermoplastic. Thermoplastic in relation to a polyurethane describes the polyurethane's property of, in a temperature range between 150° C. and 300° C. typical for the polyurethane, repeatedly softening when hot and hardening when cold and, in the softened state, repeatedly being moldable into intermediate or final articles by flowing as a molded, extruded or formed part.

The thermoplastic polyurethane used for the nonwoven (ii) is obtainable by reaction of (a-ii) isocyanates with (b-ii) isocyanate-reactive compounds, preferably having a number average molecular weight in the range from 500 to 10 000 g/mol and if appropriate (c-ii) chain extenders having a molecular weight in the range from 50 to 499 g/mol, if appropriate in the presence of (d-ii) catalysts and/or (e-ii) auxiliaries.

The components (a-ii), (b-ii) and also, if appropriate (c-ii), (d-ii) and/or (e-ii) customarily used in the preparation of polyurethanes will now be described by way of example:
a) Useful organic isocyanates (a-ii) include commonly known aliphatic, cycloaliphatic, araliphatic and/or aromatic isocyanates, examples being hexamethylene diisocyanate (HDI), 2,2′, 2,4′ and/or 4,4′-diphenylmethane diisocyanate (MDI), hydrogenated MDI (HMDI), ethylenediphenylene diisocyanate (EDI). Preference is given to using HDI and 4,4′-MDI.
b-ii) Useful isocyanate-reactive compounds (b) include the commonly known isocyanate-reactive compounds, examples being polyesterols, polyetherols and/or polycarbonatediols, which are customarily also subsumed under the term polyols.
   These typically have a number average molecular weight in the range from 500 to 8000 g/mol, preferably in the range from 600 to 5000 g/mol and especially in the range from 800 to 3000 g/mol. They further typically have an average functionality in the range from 1.8 to 2.3, preferably in the range from 1.9 to 2.1 and in particular of 2. Average functionality refers to the average number of OH groups per polyol molecule.
   When polyether alcohols are used as (b-ii), these are generally prepared by known processes, for example by anionic polymerization with alkali metal hydroxides as catalysts and in the presence of a starter molecule comprising a plurality of reactive hydrogen atoms in attachment, from one or more alkylene oxides selected from propylene oxide (PO) and ethylene oxide (EO).
   As constituent (b-ii) it is also possible to use polyetherols obtained by ring-opening polymerization of tetrahydrofuran. These polytetrahydrofurans preferably have a functionality of about 2. They further preferably have a number average molecular weight in the range from 500 to 4000 g/mol, preferably in the range from 700 to 3000 g/mol and more preferably in the range from 900 to 2500 g/mol. Polytetrahydrofuran (=PTHF) is also known in the art under the designations of tetramethylene glycol (=PTMG), polytetramethylene glycol ether (=PTMEG) or polytetramethylene oxides (=PTMOs).
   When polyester alcohols are used as constituent (b-ii), they are typically prepared by condensation of polyfunctional alcohols having 2 to 12 carbon atoms and preferably 2 to 6 carbon atoms with polyfunctional carboxylic acids having 2 to 12 carbon atoms, examples being succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalene dicarboxylic acids.
   A preferred embodiment utilizes a constituent (b-ii) comprising a polyesterol having a number average molecular weight in the range from more than 400 to 5000 g/mol, preferably in the range from more than 500 to 3000 g/mol and more preferably in the range from 1000 to 2500 g/mol.
   Preferred polyols are poly THF and also polyesterols based on adipic acid, especially polyesterols obtainable by condensation of adipic acid with 1,4 butanediol, 1,2 ethylene glycol, 2-methylpropane-1,3-diol or 3-methyl-1,5 diol or mixtures thereof.
c-ii) Useful chain extenders (c-ii) include commonly known aliphatic, araliphatic, aromatic and/or cycloaliphatic compounds having a molecular weight in the range from 50 to 499, preferably 2-functional compounds, examples being diamines and/or alkanediols having 2 to 10 carbon atoms in the alkylene radical, in particular 1,4-butanediol, 1,6-hexanediol and/or di-, tri-, tetra-, penta-, hexa-, hepta-, octaalkylene glycols having 3 to 8 carbon atoms, preferably the corresponding oligo- and/or polypropylene glycols, including mixtures of chain extenders. Particular preference is given to using dialcohols as chain extenders, 1,4 butanediol being used in particular.
d-ii) Useful catalysts, which accelerate in particular the reaction between the NCO groups of the diisocyanates (a-ii) and the hydroxyl groups of the building block components (b-ii) and (c-ii), are compounds known in the prior art. Examples thereof are tertiary amines and also, in particular, organic metal compounds such as titanic esters, iron compounds such as for example iron-(i) acetylacetonate, tin compounds, examples being tin diacetate, tin dioctoate, tin dilaurate or the tin dialkyl salts of aliphatic carboxylic acids such as dibutyltin diacetate, dibutyltin dilaurate or the like. Preference is given to using organic metal compounds, in particular tin dioctoate. When the isocyanate is an aliphatic isocyanate, the tin dioctoate is used in concentrations from 10 ppm to 1000 ppm, in particular of 100-500 ppm. When the isocyanate is an aromatic isocyanate, the tin dioctoate is used in concentrations of 0.01-100 ppm, preferably 0.1-10 ppm and more preferably 0.5-5 ppm.
e-ii) As well as catalysts (d-ii), auxiliaries (e-ii) can also be added to the building block components (a) to (c). Useful auxiliaries include for example surface-active substances, fillers, flame retardants, nucleating agents, antioxidants, gliding and demolding aids, dyes and pigments, if appropriate in addition to the present invention's stabilizer mixture further stabilizers, for example against hydrolysis, light, heat or discoloration, inorganic and/or organic fillers, reinforcing agents and plasticizers. In a preferred embodiment, component (e-ii) also includes hydrolysis stabilizers such as, for example, polymeric and low molecular weight carbodiimides.

As well as the identified components (a-ii) and (b-ii) and, if appropriate, (c-ii), (d-ii) and (e-ii), chain regulators, customarily having a molecular weight in the range from 31 to 499, can also be used. Such chain regulators are compounds which have only one isocyanate-reactive functional group, examples being monofunctional alcohols, monofunctional amines and/or monofunctional polyols. Such chain regulators make it possible to adjust flow behavior in the case of TPUs in particular to specific values. Chain regulators can be used in general in an amount of 0 to 5 parts and preferably 0.1 to 1 part by weight based on 100 parts by weight of component (b-ii), and by definition come within component (c-ii).

The conversion to the thermoplastic polyurethane preferably takes place in the absence of blowing agents. The thermoplastic polyurethane obtained is thus preferably a compact thermoplastic polyurethane.

All molecular weights cited herein have the unit [g/mol].

To adjust the hardness of the TPUs, the building block components (b-ii) and (c-ii) can be varied within relatively wide molar ratios. Useful are molar ratios of component (b-ii) to total of chain extenders (c) in the range from 10:1 to 1:10 and in particular in the range from 1:1 to 1:4, TPU hardness increasing with increasing (c) content.

The reaction can be carried out at customary characteristics, for example in the range from 800 to 1100. The characteristic is defined by 1000 times the ratio of total isocyanate groups of component (a) in the reaction to the isocyanate-reactive groups, i.e., the active hydrogens, of components (b) and (c). When the characteristic is 1000, there is one active hydrogen atom, i.e., one isocyanate-reactive function, on the part of the components (b) and (c) per isocyanate group of component (a). At characteristics above 1000, there will be more isocyanate groups than OH groups.

Preference is given to using a characteristic of 970-1000 and more preferably 980-995.

A characteristic below 1000 can be advantageous since the molar mass of the TPU is reduced as a result and hence the melt flow index rises into a range preferred for processing.

A preferred embodiment utilizes a thermoplastic polyurethane for producing the nonwoven (ii) that has a Shore hardness in the range from 70 Shore A to 54 Shore D and more preferably in the range from 80 Shore A to 95 Shore A, measured to DIN 53505.

The thermoplastic polyurethane as such typically has a density in the range from 800 to 1300 grams per liter (g/l) and preferably in the range from 1000 to 1250 g/l.

A preferred embodiment utilizes a thermoplastic polyurethane for producing the nonwoven (ii) that has an MFR melt flow index of 40-1000 (210° C., 21 kg), more preferably an MFR of 60-600, even more preferably an MFR of 60-200 measured to DIN EN ISO 1133.

The TPUs can be prepared by known processes continuously, for example by one shot or the prepolymer process using reaction extruders or the belt process, or batchwise by the familiar prepolymer operation. In these processes, the components (a), (b) and if appropriate (c), (d) and/or (e) which are made to react can be mixed with each other in succession or simultaneously, the reaction ensuing immediately.

In the extruder process, the building block components (a), (b) and also, if appropriate, (c), (d) and/or (e) are introduced into the extruder individually or as a mixture, reacted for example at temperatures from 100 to 280° C. and preferably from 140 to 250° C., and the TPU obtained is extruded, cooled and pelletized.

The nonwovens (ii) comprising thermoplastic polyurethane can typically be produced from above-described thermoplastic polyurethane by the conventional meltblown process or spunbond process. Meltblown processes and spunbond processes are known to those skilled in the art.

The nonwovens which are formed in the processes generally differ in terms of their mechanical properties and their consistency. Nonwovens (ii) produced by the spunbond process are particularly stable both horizontally and vertically, but have an open-celled structure.

Nonwovens (ii) produced by the meltblown process have a particularly dense network of fibers and hence form a very effective barrier to liquids.

Meltblown nonwovens (ii) are preferably used.

To produce a TPU nonwoven by the meltblown process, a commercial plant for producing meltblown nonwovens can be used. Such plant is available from Reifenhäuser of Germany for example.

Typically, in a meltblown process, the TPU is melted in an extruder and fed by means of customary ancillaries such as melt pumps or filters to a spinning manifold. Here, the polymer generally flows through nozzles and, at the nozzle exit, is attenuated by an airstream to form a filament. The attenuated filaments are typically laid down on a drum or belt and forwarded.

A preferred embodiment utilizes a single-screw extruder having a compression ratio of 1:2-1:3 and particularly preferably 1:2-1:2.5.

It is preferable to employ in addition a three-zone screw having a length to diameter (L/D) ratio of 25-30. The three zones are preferably equal in length. The three-zone screw preferably has throughout a constant pitch of 0.8-1.2 D and particularly preferably 0.95-1.05 D. The clearance between the screw and the barrel is >0.1 mm, preferably 0.1-0.2 mm.

When a barrier screw is used as extruder screw, it is preferable to employ an overflow gap >1.2 mm.

When the screw is equipped with mixing elements, these mixing elements are preferably not shearing elements.

The nonwoven plant is typically dimensioned such that the residence time of the TPU is as short as possible, i.e., <15 min, preferably <10 min and more preferably <5 min.

TPU is typically processed at between 180° C. and 220° C., depending on its hardness. Surprisingly, however, it has now emerged that TPU nonwovens are particularly efficient to produce when the processing temperatures are higher than the customary recommended processing temperatures. Preferably, the thermoplastic polyurethane is processed at the following temperatures:

for TPU having a Shore hardness in the range from 75 A to 85 A:

adapter at 180° C. to 240° C. and more preferably at temperatures in the range from 200° C. to 220° C.

head at 180° C. to 240° C. and more preferably at temperatures in the range from 200° C. to 220° C.

nozzle at 180° C. to 240° C. and more preferably at temperatures of 200° C. to 220° C.;

for TPU having a Shore hardness >85 A, preferably 90 A-98 A:

adapter at 200° C. to 260° C. and more preferably at temperatures in the range from 220° C. to 240° C.

head at 200° C. to 260° C. and more preferably at temperatures in the range from 220° C. to 240° C.

nozzle at 200° C. to 260° C. and more preferably at temperatures of 220° C. to 240° C.

The composite element of the present invention, as well as the covering layer (iii) and the nonwoven (ii), comprises a polyurethane foam (i).

The polyurethane foam (i) is obtainable by reacting polyurethane system components comprising a polyisocyanate component and a polyol component.

The isocyanate component comprises polyisocyanates (a-i).

The polyol component comprises polyols (b-i) and if appropriate blowing agents (c-i), catalysts (d-i) and additives (e-i), such as flame retardants, dyes, pigments, stabilizers, fillers and the like.

The utilized polyisocyanates (a-i) comprise isocyanates customary in the polyurethane field. Aliphatic, cycloaliphatic, arylaliphatic and aromatic polyfunctional isocyanates are contemplated in general. Preference is given to using aromatic di- and polyisocyanates. Preferred examples are 2,4- and 2,6-tolylene diisocyanate and also any mixtures of these isomers; 2,2′-, 2,4′- and 4,4′-diphenylmethane diisocyanates and also any mixtures of these isomers; mixtures of 2,2′-, 2,4′- and 4,4′-diphenylmethane diisocyanates and polyphenyl polymethylene polyisocyanates (crude MDI). Alternatively, it is possible to use mixtures of tolylene diisocyanates and crude MDI.

The polyisocyanates (a-i) may also be employed in the form of polyisocyanate prepolymers. Prepolymers are generally prepared by reacting the described polyisocyanates (a-i), for example at temperatures from 20° C. to 100° C. and preferably at about 80° C., with hereinbelow described polyols (b-i) to form a prepolymer. The polyol/polyisocyanate ratio is generally chosen such that the NCO content of the prepolymer is in the range from 20% to 32% by weight and preferably in the range from 25% to 31% by weight.

Polyether alcohols or polyester alcohols are generally used as polyols (b-i). However, other hydroxyl-containing polymers also come into consideration, examples being polyesteramides, polyacetals.

Suitable polyester alcohols are usually prepared by condensation of polyfunctional alcohols, preferably diols, having 2 to 12 carbon atoms and preferably 2 to 6 carbon atoms, for example hexanediol, with polyfunctional carboxylic acids having 2 to 12 carbon atoms, examples being adipic acid and/or phthalic acid. The polyether alcohols used usually have a functionality between 2 and 8, in particular 4 to 3, more preferably 2-3.

Polyether alcohols are preferably used as polyols (b-i). Suitable polyether alcohols are described hereinbelow under the heading of component (b-i-1).

The polyether polyols used generally have a (b-i-1) OH number in the range from 15 to 200, preferably in the range from 20 to 120 and more preferably in the range from 22 to 90, and a nominal functionality in the range from 2 to 4 and preferably in the range from 2.2 to 2.9.

If appropriate, the component (b-i) may also comprise further compounds having isocyanate-reactive hydrogen atoms, in which case these compounds preferably bear two or more reactive groups selected from OH groups, SH groups, NH groups, NH₂ groups and acidic CH groups, for example β-diketo groups, in the molecule. Depending on the presence of these compounds in the component (b), polyurethanes shall in the realm of this invention generally comprise polyisocyanate-polyaddition products, including polyureas for example.

In a preferred embodiment, the polyols (b-i) comprise one or more constituents selected from:
(b-i-1) polyether polyols, preferably having an OH number of 15 to 200,
(b-i-2) polymer polyols,
(b-i-3) crosslinking agents and
(b-i-4) cell openers.

The employed polyether polyols (b-i-1) are generally prepared according to familiar processes, for example by anionic polymerization with alkali metal hydroxides, such as sodium hydroxide or potassium hydroxide, as catalysts and in the presence of at least one starter molecule comprising 2 to 4 reactive hydrogen atoms in attachment from one or more alkylene oxides, preferably selected from propylene oxide (PO) and ethylene oxide (EO).

Useful polyether polyols (b-i-1) further include so-called low-unsaturation polyether polyols. Low-unsaturation polyols are in the realm of this invention in particular polyether alcohols comprising less than 0.02 meq/g and preferably less than 0.01 meq/g of unsaturated compounds. Such polyether alcohols are prepared by addition of ethylene oxide and/or propylene oxide and mixtures thereof onto at least difunctional alcohols in the presence of so-called double metal cyanide catalysts.

The alkylene oxides can be used individually, in alternating succession or as mixtures. The use of an EO/PO mixture leads to a polyether polyol having a random distribution of PO/EO units. It is possible to start with a PO/EO mixture and then to use just PO or EO before discontinuation of the polymerization, in which case a polyether polyol with as the case may be PO or EO end cap is obtained.

Useful starter molecules include for example water, organic dicarboxylic acids, diamines, for example unsubstituted or mono- and dialkyl-substituted ethylenediamine, diethylenetriamine, triethylenetetramine, 1,3-propylenediamine and/or 1,3- or 1,4-butylenediamine. Useful starter molecules further include alkanolamines, for example ethanolamine, N-methylethanolamine, N-ethylethanolamine, dialkanolamines, for example diethanolamine, N-methyldiethanolamine, N-ethyldiethanolamine and trialkanolamines such as, for example, triethanolamine and ammonia. Useful starter molecules further include dihydric, trihydric or tetrahydric alcohols, such as ethanediol, 1,2-propanediol, 1,3-propanediol, diethylene glycol, dipropylene glycol, 1,4-butanediol, 1,6-hexanediol, glycerol and/or pentaerythritol.

The polyether polyols are individuals or in the form of a mixture of two or more of the aforementioned polyether polyols.

In general, the polyether polyols used have a (b-i-1) OH number in the range from 15 to 200, preferably in the range from 20 to 120 and more preferably in the range from 22 to 90 and a nominal functionality in the range from 2 to 4 and preferably in the range from 2.2 to 2.9.

Constituent (b-i-2) comprises so-called polymer polyols, frequently also known as graft polyols. These polymer polyols are customarily prepared by free radical polymerization of suitable olefinic monomers, examples being styrene, acrylonitrile, acrylates and/or acrylamide, in a polyetherol serving as a grafting base. The side chains are generally formed by the transfer of free radicals from growing polymer chains to polyether polyols. The polymer polyol, as well as the graft copolymer, predominantly comprises the homopolymers of the olefins, dispersed in unchanged polyetherol.

A preferred embodiment comprises preparing acrylonitrile, styrene, in particular styrene and acrylonitrile in a ratio between 1:1 to 3:1, as monomers and also if appropriate in the presence of further monomers, of a macromer, of a moderator and using a free radical initiator, usually azo or peroxide compounds, in a polyetherol or polyesterol as a continuous phase.

Useful base polyetherols typically include compounds having a hydroxyl group functionality in the range from 1.8 to 8 and preferably in the range from 2 to 3, a hydroxyl number in the range from 20 to 100 mg KOH/g and preferably in the range from 25 to 70 mg KOH/g, prepared by anionic, cationic or neutral polymerization (DMC) of alkylene oxides, preferably ethylene and/or propylene oxide.

The polymer polyols (b-i-2) are preferably used in a mixture with polyether polyols (b-i-1). A preferred embodiment comprises the polymer polyol (b-i-2) in an amount from 5% to 50% by weight and preferably from 6% to 30% by weight and more preferably from 8% to 20% by weight, based on the total weight of component (b-i).

In a preferred embodiment, the polyol component (b-i) further comprises crosslinking agents as constituent (b-i-3). Useful crosslinking agents include for example polyols, preferably polyether polyols, having a nominal functionality of more than 2 and preferably in the range from 3 to 4 and having an OH number of more than 200 to 2000 and preferably in the range from 500 to 1200.

The amount of crosslinking agent (b-i-3) is typically in the range from 0.1% to 5% by weight, preferably in the range from 0.5% to 4% by weight and more preferably in the range from 1% to 3% by weight, based on the total weight of component (b-i).

In a preferred embodiment, the polyol component (b-i) further comprises cell openers as constituent (b-i-4). Useful cell openers include for example polyether polyols having an ethylene oxide content of more than 50% by weight and preferably of more than 65% by weight, based on the total weight of alkylene oxides used. These polyether polyols preferably have a nominal functionality in the range from 2 to 3. These polyether polyols preferably further have an OH number in the range from 25 to 120 and more preferably in the range from 30 to 80.

The amount of cell opener (b-i-4) is typically in the range from 0.1% to 35% by weight, preferably in the range from 1% to 5% by weight and more preferably in the range from 2% to 4% by weight, based on the total weight of component (b-i).

Commonly known chemically or physically acting compounds can be used as blowing agent (c-i). Water is a preferred chemically acting blowing agent. Examples of physical blowing agents are inert (cyclo)aliphatic hydrocarbons having 4 to 8 carbon atoms, which vaporize under the conditions of polyurethane formation. A preferred embodiment utilizes water as sole blowing agent.

The amount of blowing agent used depends predominantly on the target density for the foams. In general, water is used from 0% to 5% by weight and preferably from 0.1% to 3% by weight. In general, physically acting blowing agents can further be used from 0% to 8% by weight and preferably from 0.1% to 5% by weight. Carbon dioxide is also a useful blowing agent, and is preferably dissolved as a gas in the starting components.

It is preferable to use water and/or carbon dioxide as blowing agent.

Useful catalysts for preparing the polyurethane foams of the present invention include the customary and known polyurethane formation catalysts (d-i), examples being organic tin compounds, such as tin diacetate, tin dioctoate, dibutyltin dilaurate, and/or strongly basic amines such as diazabicyclooctane, triethylamine or preferably triethylenediamine or bis(N,N-dimethylaminoethyl) ether. The catalysts are preferably used in an amount from 0.1% to 3% by weight and preferably from 0.5% to 2% by weight, based on the total weight of component (b-i).

The reaction of the components (a-i) and (b-i) is effected if appropriate in the presence of (e-i) auxiliary and/or additive materials, examples being cell regulators, release agents, pigments, reinforcing materials such as glass fibers, surface-active compounds and/or stabilizers against oxidative, thermal, hydrolytic or microbial degradation or aging.

The density of the polyurethane foams (i) is typically in the range from 25 to 500 g/l, advantageously in the range from 30 to 250 g/l, preferably in the range from 35 to 100 g/l, more preferably in the range from 40 to 80 g/l and even more preferably in the range from 45 to 70 g/l.

To prepare the polyurethane foam (i) resulting from the reaction of the polyurethane system components (a-i), (b-i) and if appropriate (c-i) to (e-i), the polyurethane system components (a-i), (b-i) and if appropriate (c-i) to (e-i) are mixed via customary high or low pressure mix heads and reacted (i.e., introduced into the mold) in such amounts that the equivalent ratio of NCO groups to the sum total of the reactive hydrogen atoms is in the range from 1:0.8 to 1:1.25 and preferably in the range from 1:0.9 to 1:1.15. A ratio of 1:1 here corresponds to an NCO index of 100.

The composite elements of the present invention comprise if appropriate a covering layer (iii), nonwoven of thermoplastic polyurethane (ii) and polyurethane foam (i).

There is typically a bond between the nonwoven (ii) and the polyurethane foam (i) in that the forces of adhesion between the nonwoven (ii) and the polyurethane foam (i) are greater than the forces of cohesion within the polyurethane foam. Consequently, it is the foam layer (i) which ruptures in the event of a tensile load and not the bond between (i) and (ii).

The present invention further provides a process for producing a composite element comprising
i) a polyurethane foam,
ii) a nonwoven of thermoplastic polyurethane, and
iii) if appropriate a covering layer,
   comprising the steps of:
1) if appropriate introducing the covering layer (iii) into a mold,
2) introducing the nonwoven (ii) into the mold,
3) applying polyurethane system components, and
4) reacting the polyurethane system components to form a polyurethane foam (i).

The process of the present invention is carried out in a mold. The mold used preferably comprises a bottom part and a top part. The bottom and/or top parts used are in general mold halves whose surface consists for example of steel, aluminum, enamel, Teflon, epoxy resin or some other polymeric material of construction, and the surface may be chromed, for example hard chromed, if appropriate. The molds should preferably be temperature controllable in order that the preferred temperatures may be set. To achieve the necessary clamping/locking force, it is preferable for one half of the mold to be pressurized.

The optional covering layer (iii) is generally produced in a separate operation. Step (1) of the process according to the present invention comprises introducing the covering layer (iii) into a mold, preferably by placing it on the bottom surface of an open mold. It is preferable to deep draw the covering layer before it is introduced into the mold. The covering layer is preferably placed with the later visible side face down in the bottom part of the mold. In a preferred embodiment, the covering layer is fixed to the bottom part of the mold by applying a reduced pressure, for example by means of vacuum nozzles.

Step (2) of the process according to the present invention comprises introducing the nonwoven (ii) comprising the hereinabove described thermoplastic polyurethane. When a covering layer has already been inserted in step (1), the nonwoven (ii) is preferably placed on top of the covering layer (iii). Preferably, the nonwoven is adhesively bonded to the covering layer, for example by means of an adhesive and in particular by means of a hotmelt adhesive, in the process.

In one embodiment, steps (1) and (2) of the process according to the present invention may be performed “in one step”. In this case, a laminate of covering layer (iii) and nonwoven (ii) may be introduced into the mold. If appropriate, the laminate has been deep drawn before it is introduced into the mold.

Step (3) of the process according to the present invention comprises introducing liquid components of the polyurethane system. The polyurethane system components comprise the hereinabove described constituents (a-i), (b-i) and if appropriate (c-i) to (e-i). The polyurethane system components are typically introduced by pouring (preferably by means of high pressure machines, alternatively by means of low pressure machines) or spraying.

Flame lamination of the nonwoven (ii) is typically not necessary to achieve the bond between the nonwoven (ii) and the foam (i) and preferably is not carried out.

In one embodiment, the polyurethane system components are disbursed into the open mold onto the nonwoven, preferably by means of a robot. The mold is preferably closed before the liquid PU mixture starts to foam. This embodiment is particularly useful for producing seats or carpets.

In an alternative embodiment, the polyurethane system components are injected into the closed mold onto the nonwoven. This embodiment is particularly suitable for producing carpets.

Step (4) of the process according to the present invention comprises the polyurethane system components reacting to form a polyurethane foam (i). The reaction typically takes place at temperatures in the range from 20 to 60° C. for the mold. It may be noted at this point that the reaction in the strictly chemical sense already starts in the course of the components being mixed.

The foaming of the polyurethane system components in the closed mold is effective to:
1. completely fill the mold with polyurethane foam
2. bond the polyurethane foam (i) to the nonwoven (ii) without the latter becoming drenched through.

The polyurethane foam is typically allowed to cure for 0.5 to 5 minutes and preferably 1 to 2 minutes before the mold is opened and the resulting composite element is removed.

Cycling times of 1 to 15 minutes and preferably of 2 to 5 minutes result in general for the process of the present invention. The cycling time is the time for a complete cycle, i.e., the time from introducing the covering layer to removing the ready-produced structural component.

The composite elements of the present invention are generally used for seats or carpets.

Examples of seats are seats in means of transport, for example auto seats, train seats, aircraft seats; seats for interiors, for example couch seats and/or cushions for office seats.

Examples of carpets are carpets in means of transport, for example auto carpets, train carpets, aircraft carpets and/or seats for interiors, for example floor carpets.

The present invention thus also provides a seat comprising the composite element of the present invention. More particularly, the seat of the present invention is an auto seat. The present invention further provides a carpet comprising the composite element of the present invention.

The examples which follow illustrate the invention.

### EXAMPLES

### Example 1

### Producing a Thermoplastic Polyurethane Nonwoven

Elastollan® B 95 A was produced on a nonwoven plant from Reifenhäuser. The TPU being advanced through an extruder at an average throughput rate of 100 kg/h was melted at a temperature rising gradually from 200° C. to 240° C. and spun through a spinning manifold. Process air temperature was 240° C. Die collector distance (DCD) was 20 cm. Belt speed was adjusted so that the basis weight of the nonwoven was 200 g/m².

### Example 2

### Producing a Thermoplastic Polyurethane Nonwoven

Elastollan® B 95 was produced on a nonwoven plant from Reifenhäuser. The TPU being advanced through an extruder at an average throughput rate of 100 kg/h was melted at a temperature rising gradually from 200° C. to 240° C. and spun through a spinning manifold. Process air temperature was 240° C. Die collector distance (DCD) was 20 cm. Belt speed was adjusted so that the basis weight of the nonwoven was 50 g/m².

### Example 3

### Producing a Thermoplastic Polyurethane Nonwoven

Elastollan® 1180 A was produced on a nonwoven plant from Reifenhäuser. The TPU being advanced through an extruder at an average throughput rate of 100 kg/h was melted at a temperature rising gradually from 200° C. to 240° C. and spun through a spinning manifold. Process air temperature was 240° C. Die collector distance (DCD) was between 10 cm and 60 cm. Belt speed was adjusted so that the basis weight of the nonwoven was 100 g/m².

### Examples 4 to 6

### Producing Composite Elements Comprising Nonwovens and Polyurethane Foams

The ingredients reported in table 1 were used to produce the polyurethane foam (i) for examples 4 to 6. The reported ingredients were mixed by means of a high pressure mix head and reacted to form a polyurethane foam. Examples 4 and 5 are comparative examples.

TABLE 1

| | Comparative | Comparative | Inventive |
|---|---|---|---|
| | example 4 | example 5* | example 6 |
| Component | parts by weight | parts by weight | parts by weight |
| Lupranol ® 2090 | 83.20 | 82.10 | 83.20 |
| Lupranol ® 2032 | 10.00 | 10.00 | 10.00 |
| Lupranol ® | 1.50 | 1.50 | 1.50 |
| VP9349 | | | |
| Glycerol | 0.90 | 0.90 | 0.90 |
| Lupragen ® N 201 | 0.60 | 0.60 | 0.60 |
| Tegostab ® B | 0.10 | 0.10 | 0.10 |
| 8680 | | | |
| Laromin ® C 260 | | 0.50 | |
| Lupranat ® M 20A | | 0.60 | |
| Lupragen ® N 211 | 0.20 | 0.20 | 0.20 |
| Jeffcat ® ZF 10 | 0.1 | 0.1 | 0.1 |
| Water | 3.4 | 3.4 | 3.4 |

### Comparative Example 5

The comparative example 5 parts by weight of Lupranol® 2090, Lupranole® 2032, Lupranol® VP9349, glycerol, Lupragen® N 201, Tegostab® B 8680 and 0.5 part by weight of Laromin® C 260 were mixed by intensive stirring. Thereafter, 0.6 part by weight of Lupranat® M 20A was added with intensive stirring. After a stirring time of 15 minutes, the reported parts by weight of water, Jeffcat® ZF 10 and Lupragen® N 211 were added and mixed in. The A component thus prepared comprised dispersed urea, in contradistinction to comparative example 4 and inventive example 6.

To prepare the polyurethane foam (i), the polyol components of examples 4 to 6 were reacted with an NCO prepolymer (NCO content: 31%, obtainable by reaction of an MDI and PMDI mixture with a polyether polyol based on glycerol and propylene oxide (OH number 42 mg KOH/g). The reaction mixture was used for backfoaming a textile material or to be more precise a nonwoven of thermoplastic polyurethane (ii).

After foaming, the penetration ability was assessed.

| | Comparative | Comparative | Inventive |
|---|---|---|---|
| Characteristic | example 4 | example 5* | example 6 |
| Polyol component viscosity | 1550 mPas | 2070 mPas | 1550 mPas |
| Nonwoven | Polyester | Polyester | TPU from |
| | | | example 1 |
| Pentetration ability** | 3-4 | 2 | 1 |

**Penetration behavior was visually assessed against a scale ranging from “1” = absolutely no penetration to “5” = full penetration to other side.

1-11. (canceled)

12. A composite element comprising
i) a polyurethane foam,
ii) a nonwoven of thermoplastic polyurethane, and
iii) if appropriate a covering layer.

13. The composite element according to claim 12 wherein said covering layer (iii) comprises textiles, webs and/or leather.

14. The composite element according to claim 12 wherein said nonwoven (ii) has a basis weight in the range from 20 to 500 g/m², measured to ISO 9073-1.

15. The composite element according to claim 12 wherein said nonwoven (ii) has a thickness in the range from 0.01 to 5 millimeters (mm), measured to ISO 9073-2.

16. The composite element according to claim 12 wherein said thermoplastic polyurethane used to produce said nonwoven has a Shore hardness in the range from Shore 80 A to Shore 60 D, measured to DIN 53505.

17. The composite element according to claim 12 wherein said polyurethane foam (i) is a polyurethane flexible foam having a DIN 53421 compressive stress at 10% compressing strain of less than 30 kPa.

18. The method of using a composite element comprising
i) a polyurethane foam,
ii) a nonwoven of thermoplastic polyurethane, and
iii) if appropriate a covering layer,
for producing seats or carpets.

19. A seat comprising a composite element according to claim 12.

20. A carpet comprising a composite element according to claim 12.

21. The seat according to claim 18 embodied as an auto seat.

22. A process for producing a composite element comprising
i) a polyurethane foam,
ii) a nonwoven of thermoplastic polyurethane, and
iii) if appropriate a covering layer,
comprising the steps of:
1) if appropriate introducing the covering layer into a mold,
2) introducing the nonwoven into the mold,
3) applying polyurethane system components, and
4) reacting the polyurethane system components to form a polyurethane foam.
